(19) United States
(12) Patent Application Publication
(10) Pub. No.: US 2012/0018932 A1
(43) Pub. Date: Jan. 26, 2012

(54) Lift Assist Device and Associated Methods

(76) Inventor: W. Cody Fairbanks, Sandy, UT (US)

(21) Appl. No.: 13/190,754

(22) Filed: Jul. 26, 2011

Related U.S. Application Data
(60) Provisional application No. 61/367,728, filed on Jul. 26, 2010.

(51) Int. Cl. F16F 1/36

(52) U.S. Cl. 267/69

(57) ABSTRACT

The present invention provides devices to assist a subject in lifting and associated methods. In one aspect for example, a lift assist device can include a harness operable to be secured about or to a torso of a user, and at least one cord having a first end operably coupled to the harness and a second end operably coupleable to a forelimb of the user. Additionally, at least one of the harness and the at least one cord are substantially elastic, and where the first and second ends of the at least one cord are positioned to assist the user in lifting an object. In one aspect, the at least one cord is substantially elastic and the harness is substantially inelastic.

### PRIORITY DATA

This application claims the benefit of U.S. Provisional Patent Application Ser. No. 61/367,728, filed on Jul. 26, 2010, which is incorporated herein by reference.

### BACKGROUND OF THE INVENTION

Preventing back injuries is a major workplace safety challenge. According to the Bureau of Labor Statistics, greater than 1 million workers suffer back injuries each year, and back injuries account for one of every five workplace injuries or illnesses. Approximately ¼ of all workers compensation claims involve back injuries, and these injuries cost industry billions of dollars in addition to the pain and suffering experienced by the employees. The Bureau of Labor Statistics survey further showed that four out of five back injuries were to the lower back, and that three out of four occurred while the employee was lifting.

No approach has been shown to totally eliminate back injuries caused by lifting, although it is believed that a substantial portion can be prevented through back safety training, control programs, and ergonomic design of work tasks.

### SUMMARY OF THE INVENTION

The present invention provides devices and associated methods to assist a subject in lifting various objects. In one exemplary aspect, a lift assist device can include a harness operable to be secured about or to a torso of a user, and at least one cord having a first end operably coupled to the harness and a second end operably coupleable to a forelimb of the user. Additionally, at least one of the harness and the at least one cord can be substantially elastic, and the first and second ends of the at least one cord can be positioned to assist the user in lifting an object. In one aspect, the at least one cord is substantially elastic and the harness is substantially inelastic.

In another aspect, the lift assist device can also include a first elastic cord and a second elastic cord, with the first elastic cord having a first end operably coupled to the harness and a second end operably coupleable to a first forelimb of the user, with the second elastic cord having a first end operably coupled to the harness and a second end operably coupleable to a second forelimb of the user. In this manner, the first and second ends of the first and second elastic cords are positioned to assist the user in lifting an object. In one specific aspect, the first and second ends of the first and second elastic cords are positioned to affect a posture of a back of the user during lifting. In another specific aspect, the first ends of the first and second elastic cords are coupled to a dorsal region of the harness. In a further specific aspect, the first and second elastic cords extend from the dorsal region of the harness beneath the first and second forelimbs when coupled to the user, such that tension applied to the first and second elastic cords applies a force to the dorsal region that affects the posture of the back of the user during lifting.

It is contemplated that cords, whether they be elastic or inelastic, can be coupled to various regions of the forelimb subject. For example, in one aspect the second end of a cord includes a hand attachment operable to be coupled to a user's hand. In another aspect, the second end of a cord includes a wrist attachment operable to be coupled to a user's wrist. In yet another aspect, the second end of a cord includes a forearm attachment operable to be coupled to a user's forearm. Additionally, in some aspects the second end of a cord includes a grip attachment operable to improve a user's grip on an object being lifted.

Various harness and harness-like devices are contemplated for use in the lifting devices of the present invention. It should be noted that any harness or harness-like device that is capable of receiving attachment from a cord or cords, and that is capable of assisting a subject in lifting, is considered to be within the present scope. In one aspect for example, the harness is extendable around at least one shoulder and around the torso of the user. In another aspect, the harness further includes a belt member operable to extend around the waist of the user and a stiffening member having a proximal end coupled to the belt member and extending to a distal end adjacent the shoulders of the user when in use. In this case, the first end of the cord is typically coupled to the distal end of the stiffening member.

It is also contemplated that the harness can be associated with the containment device or other wearable item. In one aspect for example, the harness is operably coupled to a containment device carryable by the harness. In another aspect, the containment device is a camel pack or a backpack.

The present invention also provides methods of assisting a subject in lifting. For example, in one aspect a method of lifting an object can include extending forelimbs of a user to apply tension to at least two elastic cords that extend from the forelimbs to a dorsal region of the user, engaging the object with the forelimbs, and lifting the object with the user's body while the tension in the elastic cords impels the object toward the user's body. In a more specific aspect, the elastic cords extend from the forelimbs to the dorsal region by passing under the forelimbs, such that upon lifting the object the tension applied to the elastic cords is at least partially released in pulling the object toward the user while also affecting a back posture of the user. In another specific aspect, the elastic cords extend from the forelimbs to the dorsal region by passing under the forelimbs, such that upon lifting the object the tension applied to the elastic cords applies a force to the dorsal region of the user to affect a back posture of the user during lifting.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 includes a series of views of a lift assist device according to one embodiment of the present invention;

FIG. 2 includes a series of views of a lift assist device worn by a user according to another embodiment of the present invention;

FIG. 3 includes a series of views of a lift assist device according to another embodiment of the present invention;

FIG. 4 includes a series of views of a lift assist device according to another embodiment of the present invention; and

FIG. 5 includes a series of perspective views of a lift assist device used during a typical lifting operation.

The drawings will be described further in connection with the following detailed description. Further, these drawings are not necessarily to scale and are by way of illustration only such that dimensions and geometries can vary from those illustrated.

### DETAILED DESCRIPTION

Before the present invention is disclosed and described, it is to be understood that this invention is not limited to the particular structures, method steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a material” can include one or more of such materials, and reference to “the cord” can include reference to one or more of such cords.

### DEFINITIONS

In describing and claiming the present invention, the following terminology will be used in accordance with the definitions set forth below.

As used herein, the term “elastic” refers to a material that can be stretched to store elastic energy wherein the stored elastic energy is released upon relaxing of the material. In terms of the present scope, a material is defined as being elastic if the elastic energy stored upon stretching is sufficient to assist in lifting an object as described herein.

As used herein, the term “inelastic” refers to a material that does not generate sufficient stored elastic energy upon stretching to assist in lifting an object as described herein.

As used herein, the term “substantially” refers to the complete or nearly complete extent or degree of an action, characteristic, property, state, structure, item, or result. As an arbitrary example, an object that is “substantially” enclosed is an object that is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As an arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 micrometers to about 5 micrometers” should be interpreted to include not only the explicitly recited values of about 1 micrometer to about 5 micrometers, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value. Furthermore, such an interpretation should apply regardless of the breadth of the range or the characteristics being described.

The Invention

The present invention provides devices to assist a subject in lifting and associated methods. In one aspect for example, a lift assist device can include a harness operable to be secured about or to a torso of a user, and at least one cord having a first end operably coupled to the harness and a second end operably coupleable to a forelimb of the user. Additionally, at least one of the harness and the at least one cord are substantially elastic, and where the first and second ends of the at least one cord are positioned to assist the user in lifting an object. In one aspect, the at least one cord is substantially elastic and the harness is substantially inelastic.

Various harness and harness-like devices are contemplated for use in the lifting devices of the present invention. It should be noted that any harness device that is capable of receiving attachment from a cord or cords, and that is capable of assisting a subject in lifting, is considered to be within the present scope. In one aspect for example, the harness is extendable around at least one shoulder and around the torso of the user. In this case, a shoulder section of the harness would at least partially extend around the shoulder to assist in supporting the harness on the user. In another aspect, the harness is extendable around both shoulders and around the torso of the user. In this case, at least one shoulder section of the harness would at least partially extend around the shoulders of the user. This could be accomplished using multiple shoulder sections of the harness, wherein at least one shoulder section is distinctly associated with each shoulder. It is also contemplated that a single shoulder section could at least partially extend around both shoulders of the user.

In some aspects, a securing strap can extend between me around-the-shoulder members of the harness to assist in maintaining the position of the harness on the subject. Such securing strap can be the torso section of the harness that extends around the torso of user, or it can be separate securing strap that is distinct from the torso section of the harness. This securing strap can be positioned on a chest region (ventral) of the harness, a back region (dorsal) of the harness, or on both a chest region and a back region of the harness. The securing strap assists in maintaining the relative position between the shoulder sections of the harness. In some aspects of securing strap can include a buckle, snap, hook, or other release mechanism to assist in the removal of the harness.

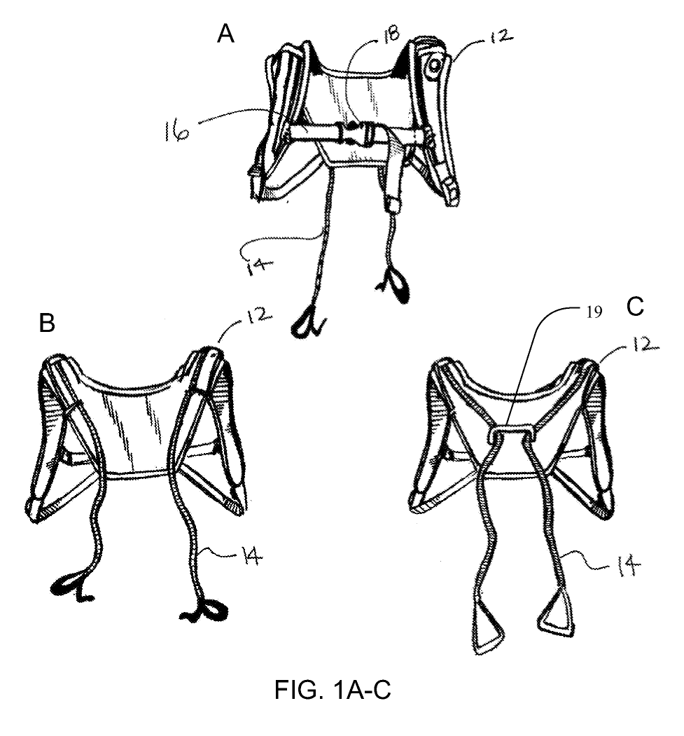

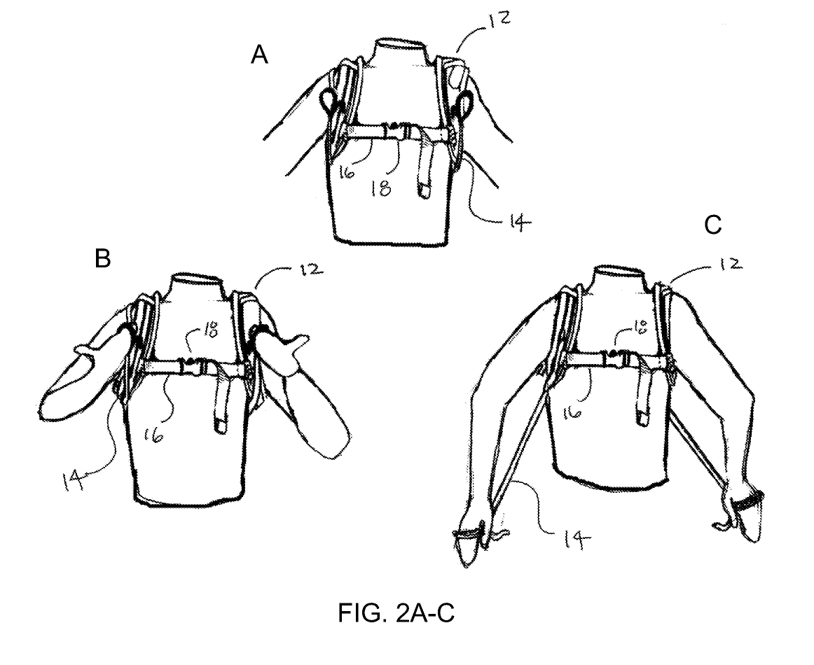

Exemplary aspects are shown in FIGS. 1-3. These figures show a harness 12, having cords 14 coupled thereto. In some aspects, the cords 14 can include limb attachments 22 and/or grip attachment 24. Also shown is a securing strap 16 with a buckle 18. FIG. 1A, for example, shows a front view of a harness 12. FIG. 1B shows a back view of a harness 12, and FIG. 1C shows a harness 12 having a cord guide 19 coupled to the back of the harness 12 through which the cords 14 can be passed. In this case, force generated in the cords during lifting is transferred through the cord guide and up to the shoulder regions of the user in order to help straighten the back during lifting and/or facilitate good lifting posture. FIG. 2 shows the harness in position on a subject during use.

In another aspect, the harness can further include a belt member operable to extend around the waist of the user. In yet another aspect, the harness can also include a stiffening member having a proximal end coupled to a belt member and extending to a distal end adjacent the shoulders of the user when in use. In this case, the first end of the cord is coupled to the distal end of the stiffening member.

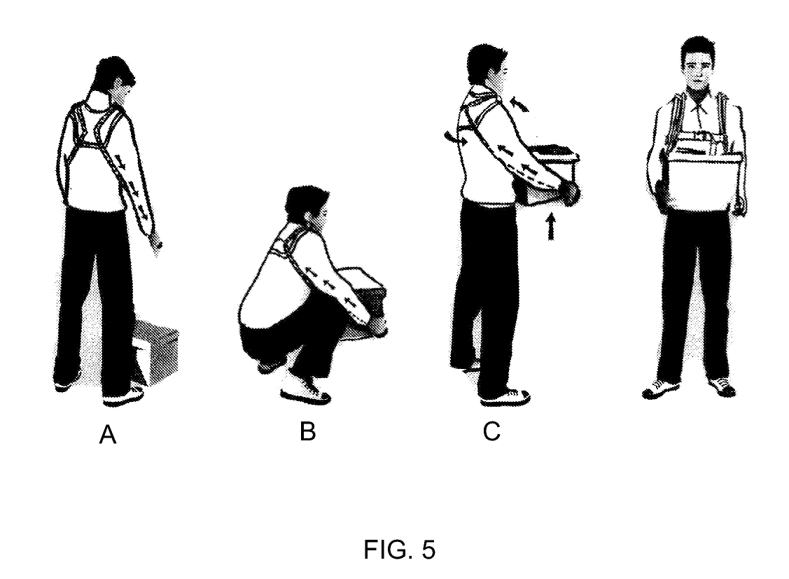

The harness generally provides a point of attachment for the one or more cords, while at the same time incorporating the lifting device into a wearable system. For the device to function as intended, at least one of the harness and the cords should be elastic. As the subject extends one or more forelimbs to grasp an object in preparation for lifting, the elastic material, whether it be the harness, the cord(s), or a combination of the harness and chord(s) is stretched to thus apply a force to the material. Upon lifting the object, the force loaded in the elastic material is released in assisting to pull the object up and toward the subject, while at the same time applying a force to the harness that assists in proper back positioning. In this way, the lift assist device utilizes elastic material to assist in lifting the object and assisting in proper back posture. (See FIG. 5)

Thus the specific design of the harness, including the material from which is made, can vary depending on the overall design of the lifting device. If the harness is intended to be inelastic, for example, it can be made from a variety of inelastic materials. Thus any inelastic material that can be used to make a harness functioning as described herein is considered to be within the present scope. Non-limiting examples of such materials can include natural leather, synthetic leathers and leather-like materials, cloth materials, canvas, nylon, wearable polymers, plastics, metals, and the like, including combinations thereof. In addition, in one aspect the harness can include bulletproofing materials. If the harness is intended to be elastic or at least partially elastic, it can be made from a variety of elastic materials. Thus any elastic material that can be used to make harness functioning as described herein is considered to be within the present scope. Non-limiting examples include natural and synthetic rubbers, elastic polymers, and the like, including combinations thereof.

It is also contemplated that the harness can be associated with the containment device or other wearable item. In one aspect for example, the harness is operably coupled to a containment device carryable by the harness. In another aspect, the containment device can be a camel pack or a backpack.

Various attachments are contemplated for coupling the cords to the harness. Such attachments will vary, however, depending on the nature and design of the lift assist device, the harness, and the cords. Non-limiting examples of such attachments can include snaps, hooks, loops, glued attachments, sewn attachments, rivets, grommets, knotted, and combinations thereof.

Additionally the materials from which cords can be made can vary depending on the design of the lift assist device. In those aspects wherein the cords are made from an inelastic material, numerous inelastic materials can be utilized. Non-limiting examples include, for example, nylons, plastics, rope, chain, natural and synthetic leather, and the like, including combinations thereof. In those aspects wherein the cords are made from any elastic material, numerous elastic materials can be utilized by many examples include, for example, elastic polymers, synthetic and natural rubbers, and the like, including combinations thereof.

It should also be understood, that either of the harness and the cords could be partially elastic and partially inelastic. For example, the elasticity of the material can be adjusted by utilizing a material that has a moderate elasticity. Or elasticity can be adjusted by forming a compound of elastic portions and inelastic portions. Additionally, in one aspect the harness and the cords can be substantially inelastic but wherein the lift assist device includes elastic attachment between the harness and the cords. In one aspect, for example, the attachment can include a elastic polymer rubber. In another aspect, the attachment can be a spring or other resilient device that functions to impart elasticity between the harness and the cords. Thus it should be noted, that any technique of generating elastic resilience between the harness and the cords should be included in the present scope.

As has been described above, the lift assist device can include at least one cord operable to attach between forearm of the user and the harness. In another aspect, the lift assist device can also include a first elastic cord and a second elastic cord, where the first elastic cord has a first end operably coupled to the harness and a second end operably coupleable to a first forelimb of the user, and where the second elastic cord has a first end operably coupled to the harness and a second end operably coupleable to a second forelimb of the user. In this way, the first and second ends of the first and second elastic cords are positioned to assist the user in lifting an object. In one specific aspect, the first and second ends of the first and second elastic cords are positioned to affect a posture of a back of the user during lifting. In another specific aspect, the first ends of the first and second elastic cords are coupled to a dorsal region of the harness. In a further specific aspect, the first and second elastic cords extend from the dorsal region of the harness beneath the first and second forelimbs when coupled to the user, such that tension applied to the first and second elastic cords applies a force to the dorsal region that affects the posture of the back of the user during lifting.

It is contemplated that cords, whether they be elastic or inelastic, can be coupled to various regions of the forelimb subject. For example, in one aspect the second end of a cord includes a hand attachment operable to be coupled to a user's hand. Such a hand attachments can include a variety of designs, such as a loop into which the fingers are inserted, a glove, and the like. In another aspect, the second end of a cord includes a wrist attachment operable to be coupled to a user's wrist. In such cases, arrest attachments can include a loop surrounding the wrist. In some cases, such a wrist loop can include a releasable a strap. In yet another aspect, the second end of a cord includes a forearm attachment operable to be coupled to a user's forearm.

Additionally, in some aspects the second end of a cord includes a grip attachment operable to improve a user's grip on an object being lifted. Non-limiting examples of such grip attachments can include hooks, tacky substances, rubberized surfaces, and the like.

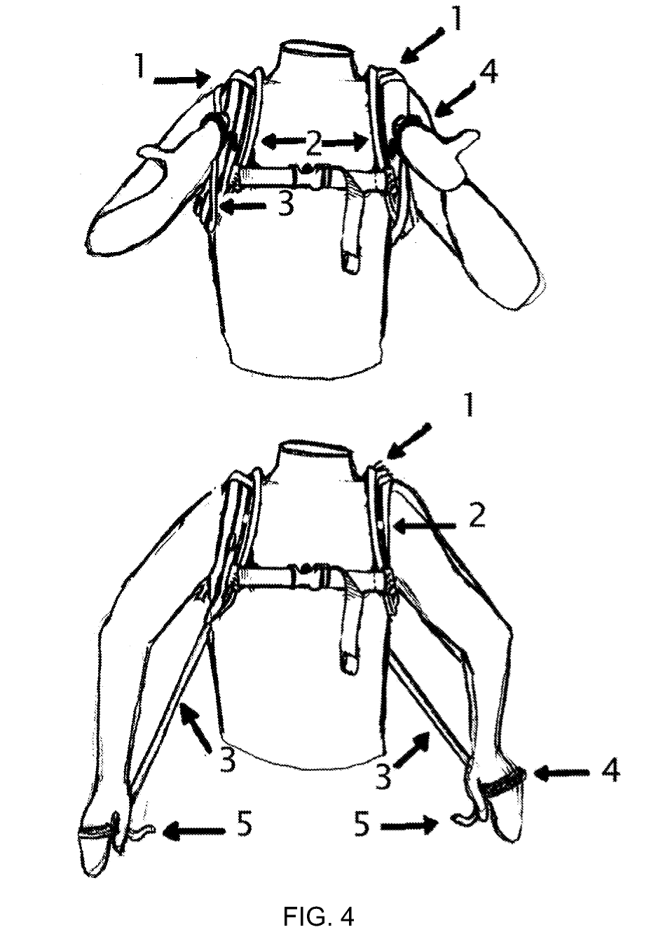

The present invention also provides methods of assisting a subject in lifting. For example, in one aspect a method of lifting an object can include extending forelimbs of a user to apply tension to at least two elastic cords that extend from the forelimbs to a dorsal and/or shoulder region of the user, engaging the object with the forelimbs, and lifting the object with the user's body while the tension in the elastic cords impels the object toward the user's body. In a more specific aspect, the elastic cords extend from the forelimbs to the dorsal region by passing under the forelimbs, such that upon lifting the object the tension applied to the elastic cords is at least partially released in pulling the object toward the user while also affecting a back posture of the user. In another specific aspect, the elastic cords extend from the forelimbs to the dorsal region by passing under the forelimbs, such that upon lifting the object the tension applied to the elastic cords applies a force to the dorsal region of the user to affect a back posture of the user during lifting. See (FIGS. 4 and 5) for additional exemplary details.

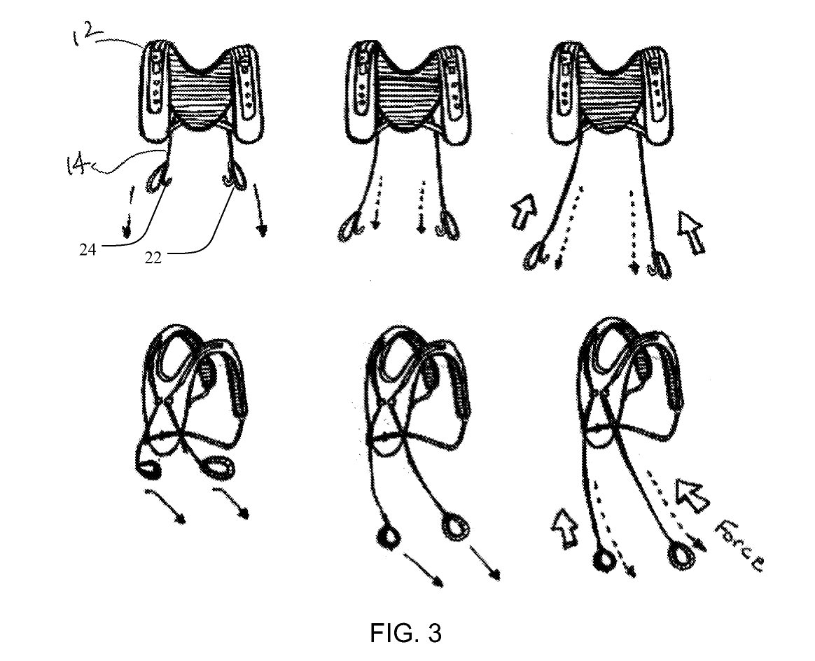

As is shown in FIG. 3, a harness 12 can include one or more cords 14 to assist lifting. In one aspect, a hand or wrist attachment 22 can be coupled to one end of the cord for attachment to the user. In another aspect, grip attachments 24 can be associated with the cords at the hand attachments in order to further assist in lifting and carrying an object. Thus, as the limbs of the user are extended to grasp an object, the cords are resiliently loaded, and such resilience assists the user in lifting the object. Additionally, the cords are attached to the harness in such a manner that the resilient force also assists in proper back position during lifting.

As is shown in the exemplary aspect in FIG. 4, a lifting harness can include cord adjusters 1 to alter the tension of the chords for lifting different weighted objects. Additionally, the harness can include cord storage attachments 2 to keep the hand attachments coupled to the harness in an easily accessible position. The user can thus store the hand attachments in a convenient location when not in use. The cords 3 are shown in a stored and extended position, and are coupled to hand attachments 4. Grip attachments 5 can also be included to facilitate grabbing and/or holding the object.

As is shown in the exemplary aspect in FIG. 5, a user is shown lifting an object. First, the user couples the hand attachments to the hands and extends the arms to resiliently load the cords (A). The user grasps the object and initiates a lifting motion (B). The cords release the resilient forces loaded therein, thus assisting in lifting the object (C). The resilient forces pull the shoulders back and pull the spine inward, thus keeping the spine in a proper lifting position. The resilient nature of the cords also assists the user in holding the object and maintaining a proper back position during carrying.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A lift assist device, comprising:
a harness, operable to be secured about or to a torso of a user;
at least one cord having a first end operably coupled to the harness and a second end operably coupleable to a forelimb of the user;
at least one of the harness and the at least one cord being substantially elastic; and
wherein the first and second ends of the at least one cord are positioned to assist the user in lifting an object.

2. The device of claim 1, wherein the at least one cord is substantially elastic and the harness is substantially inelastic.

3. The device of claim 2, further comprising:
a first elastic cord and a second elastic cord; and wherein
the first elastic cord has a first end operably coupled to the harness and a second end operably coupleable to a first forelimb of the user;
the second elastic cord has a first end operably coupled to the harness and a second end operably coupleable to a second forelimb of the user; and
the first and second ends of the first and second elastic cords are positioned to assist the user in lifting an object.

4. The device of claim 3, wherein the first and second ends of the first and second elastic cords are positioned to affect a posture of a back of the user during lifting.

5. The device of claim 3, wherein the first ends of the first and second elastic cords are coupled to a dorsal region of the harness.

6. The device of claim 5, wherein the first and second elastic cords extend from the dorsal region of the harness beneath the first and second forelimbs when coupled to the user, such that tension applied to the first and second elastic cords applies a force to the dorsal region that affects the posture of the back of the user during lifting.

7. The device of claim 1, wherein the second end of the at least one cord includes a hand attachment operable to be coupled to a user's hand.

8. The device of claim 1, wherein the second end of the at least one cord includes a wrist attachment operable to be coupled to a user's wrist.

9. The device of claim 1, wherein the second end of the at least one cord includes a forearm attachment operable to be coupled to a user's forearm.

10. The device of claim 1, wherein the second end of the at least one cord includes a grip attachment operable to improve a user's grip on an object being lifted.

11. The device of claim 1, wherein the harness is extendable around at least one shoulder and around the torso of the user.

12. The device of claim 1, wherein the harness further includes:
a belt member operable to extend around a waist of the user; and
a stiffening member having a proximal end coupled to the belt member and extending to a distal end adjacent shoulders of the user when in use, and wherein the first end of the cord is coupled to the distal end of the stiffening member.

13. The device of claim 1, wherein the harness is operably coupled to a containment device carryable by the harness.

14. The device of claim 13, wherein the containment device is a camel pack or a backpack.

15. A method of lifting an object, comprising:
extending forelimbs of a user to apply tension to at least two elastic cords that extend from the forelimbs to a dorsal region of the user;
engaging the object with the forelimbs;
lifting the object with the user's body while the tension in the elastic cords impels the object toward the user's body.

16. The method of claim 15, wherein the elastic cords extend from the forelimbs to the dorsal region by passing under the forelimbs, such that upon lifting the object the tension applied to the elastic cords is at least partially released in pulling the object toward the user while also affecting a back posture of the user.

17. The method of claim 15, wherein the elastic cords extend from the forelimbs to the dorsal region by passing under the forelimbs, such that upon lifting the object the tension applied to the elastic cords applies a force to the dorsal region of the user to affect a back posture of the user during lifting.
